(19) United States
(12) Patent Application Publication
(10) Pub. No.: US 2026/0162508 A1
(43) Pub. Date: Jun. 11, 2026

(54) FOOD PROCESSING MACHINE, LIFTING DEVICE, AND METHOD WITH PROJECTION DEVICE FOR A WARNING SYMBOL

(71) Applicant: Albert Handtmann Maschinenfabrik GmbH & Co. KG, Biberach (DE)

(72) Inventors: Michael FÜRGUT, Biberach (DE); Bernd MAILE, Oggelshausen (DE)

(21) Appl. No.: 19/409,521

(22) Filed: Dec. 4, 2025

(30) Foreign Application Priority Data
Dec. 5, 2024 (EP) 24 217 754

(51) Int. Cl. G08B 5/36; A22C 11/02; G03B 29/00

(52) U.S. Cl. CPC G08B 5/36; A22C 11/02; G03B 29/00

(57) ABSTRACT

The disclosure relates to a food processing machine, in particular a filling machine or cutter, with a lifting device by way of which a container for food held in a receptacle can be moved from a lower position U to an upper emptying position E and back. In order to make a corresponding food processing machine and a corresponding Method even safer, a projection device is provided which is configured and arranged such that an optical warning symbol can be projected onto and/or across the ground in order to mark a collision hazard area caused by thee lifting device.

### CROSS REFERENCE TO RELATED APPLICATION

The present application claims priority to European Patent Application No. 24217754.1 filed on Dec. 5, 2024. The entire contents of the above-listed application are hereby incorporated by reference for all purposes.

### TECHNICAL FIELD

The disclosure relates to a food processing machine, a lifting device, as well as to a method for feeding a food processing machine.

### BACKGROUND

In the food industry, lifting devices are used to feed food processing machines, such as vacuum filling machines or cutters. These lifting devices are typically configured as arm lifting devices, as mast lifting devices, or as tilting devices of the swing-loading type and can be attached to a machine, for example, a vacuum filling machine, a cutter, a meat grinder, a mixer, or a floor hopper or silo of a filling machine, etc.

### SUMMARY

These lifting devices are configured to receive containers that are standardized in part, for example, mobile (i.e., equipped with casters) carts, in particular conveyor carts in accordance with DIN 9797, which are also referred to as sausage meat carts. The sausage meat cart is then typically placed in a receptacle of the lifting device such that it is securely locked against falling out and is lifted by the lifting device, for example, above the filling hopper of a vacuum filling machine. The sausage meat cart is there then emptied into the hopper. The sausage meat cart is then returned to its starting position by the lifting device and removed by the operator by releasing the lock on the lifting device. When feeding cutters, the cutter bowl is respectively fed.

With food processing machines, there is a risk that a person standing under the downward-moving container could be injured by an automated and therefore potentially unattended downward motion. This can also happen if the motion is started manually and a person suddenly enters the danger zone. In order for such machines to be CE-compliant, they must have certain safety mechanisms in place. In practice, this safety requirement is implemented, for example, by way of a so-called “dead man's control,” in which the operator must continuously press a button when lowering the sausage meat cart from a certain height remaining between the container or lifting device and the ground, otherwise the downward motion is stopped immediately. EP 2 489 273 B1, for example, already describes a collision detection device.

Even if the machines are safe, the automated lowering motion of the lifting devices without additional safety measures around the lifting device is considered to be critical by some customers.

However, mechanical barriers/fences are expensive, cumbersome, and pose other hazards—in any case, they complicate handling. Acoustic signals are also not useful nor effective in noisy production environments.

Starting out from there, the present disclosure is based on the object of providing a food processing machine, a lifting device, and a method for feeding a food processing machine that can increase safety in a simple manner.

According to the disclosure, this object is satisfied by the features as described herein.

According to the disclosure, the food processing machine comprises a lifting device by way of which a container for food held in a receptacle can be moved from a lower position to an upper emptying position and back. The food processing machine can be, for example, a filling machine, in particular a vacuum filling machine, a cutter, a meat grinder, or a mixer. These food processing machines have a device for receiving the food from the container, in particular a filling hopper, a floor hopper, or a silo.

Such a container can be, for example, a cart, in particular a conveyor cart or sausage meat cart. The lower position U is a position in which the container is inserted, for example, into a receptacle of the lifting device and is locked or secured there. An “upper emptying position” is the position in which the receptacle is, for example, in an upper position in which the container is tilted such that the contents can be filled, for example, into a hopper or a bowl.

According to the disclosure, the food processing machine comprises a projection device that is configured and arranged such that an optical warning symbol can be projected onto and/or across the ground to indicate a collision hazard area caused by the lifting device, i.e., to draw attention to an area of motion of the moving parts of the lifting device in which a collision with the operator could occur. This prevents people from entering this area or placing objects there. Appropriate marking further increases safety for the operator. The warning symbol then does not have to be disposed in the entire collision hazard area or area of motion, respectively, but can be disposed only in part of the hazard area or surround it. The only important thing is that the warning symbol draws attention. The warning symbol can then be displayed when a container is disposed in the receptacle, but also when the vehicle is travelling empty and no container has been inserted.

Since the warning symbol is only projected, this projection cannot be damaged by the harsh conditions in the production halls, in particular by the carts that are pushed with their wheels into the receptacles. The warning symbol can also withstand cleaning processes with high-pressure cleaners and cleaning agents.

The food processing machines are sometimes used several times a day or per shift for different applications and are positioned in different places for this purpose. Optionally, the warning symbol can then simply be moved along with them. In any case, the operator can clearly see the area where he should not stand or place anything.

The warning symbol can be, for example, a hazard warning symbol, for example a pictogram, but at least a region in a specific signal color or a frame around the hazard area. Ideally, people should not enter this area.

In addition to or as an alternative to projecting the warning symbol onto the ground, one possible embodiment is to have the warning symbol be projected as a virtual representation into the space above the ground in order to make it clear that this area must not be entered. This likewise provides additional safety when operating the food processing machine. For example, a virtual image, in particular a 3D hologram, can be projected and then also extend in the vertical direction and, even better, can be recognized from a distance.

According to an embodiment, the food processing machine comprises a housing, where the projection device is arranged such that the warning symbol can be projected laterally adjacent to the housing and/or across the ground. This is advantageous because the lifting device with the receptacle is also arranged to the side.

According to a further embodiment, the food processing machine comprises a device for receiving the food from the container, for example a filling hopper, floor hopper or silo, where the projection device is arranged such that the warning symbol can be projected laterally adjacent to the device and/or across the ground. For this purpose, a filling hopper can be arranged directly above the housing of the machine, as is generally customary, or a floor hopper or silo can be connected to other machine components in the housing via lines. The warning symbol can then advantageously be generated laterally adjacent to the floor hopper or silo in the danger zone of the lifting device.

The fact that the container can at some point obscure the projection, e.g., the warning symbol, as it moves downwards in the direction towards its lower position U is not a problem, as this only happens from a lifting height at which no one goes beneath the container or the lifting device anyway.

If the warning symbol is projected exclusively into the air, i.e., above the ground, it may be advantageous to have the distance between the lower end of the warning symbol and the ground not be too large, e.g., the warning symbol to be within the operator's field of vision.

It may be advantageous to have the projection device be arranged such that the warning symbol can be projected at least in part onto an area of the ground that is below the receptacle with the container inserted, when viewing the receptacle with the inserted container from a lower position, or surrounds this area at least in sections. This means that the operator can be effectively prevented from entering an area where the receptacle with or without the container could strike him from above. In the event that the warning symbol is projected onto the ground, the projection device can be arranged such that the warning symbol is disposed at least in part in or above an area of the receptacle with the container inserted, or surrounds this area at least in part, when viewing the receptacle with the inserted container in a lower position. This allows the area in which the operator should not be under any circumstances to be clearly marked.

Optionally, the lifting device is an arm lifting device, a mast lifting device, or a tilting device of the swing-loading type. In the case of an arm lifting device, the warning symbol does not have to extend below the entire area of the lifting arm, as the operator knows that when a corresponding warning symbol is projected onto and/or above the ground, he must also not stand near the warning symbol.

Optionally, the projection device comprises an optical projector that can project an image onto a surface, presently the ground, and/or a projector for generating a virtual image in space, for example a 3D hologram projector. Such projectors can be easily integrated into the food processing machine and controlled, for example, by the control system.

Advantageously, the projection device is optionally arranged laterally at the food processing machine, for example integrated into the housing of the food processing machine, optionally in the side wall, or on a device for receiving the food, for example a filling hopper, floor hopper, or silo, or on the ground of the food processing machine.

If the projection device is arranged at the food processing machine, for example laterally, the warning signal can be projected well into the collision danger zone from this location. To have the projection device be arranged at the housing of the food processing machine may be advantageous because the housing is static, i.e., is no moving part, so that the warning symbol can always be displayed in the same place.

If, for example, a floor hopper or silo is located at a distance from the remainder of the food processing machine by way of lines, then the projection device is disposed in this area.

The projection device can also be arranged at the lifting device, for example on a static part of the lifting device.

The projection device is optionally attached to a static part so that the warning symbol does not move.

According to an embodiment, the food processing machine comprises a control system that controls the projection device, where the projection device is configured to be switched on and off and is switched on at the latest when the lifting device receives a signal from the control system to lift the receptacle. This ensures that nobody is standing in the collision hazard area, even at a time when the receptacle is moving upwards.

The projection device can also be attached separately, for example to a wall, ceiling or separate holder, and connected to a control device of the food processing machine in such a way that the projection device can be actuated by the control device. In this embodiment, the warning symbol can be static. It is also possible to arrange several projection devices at different locations in the production room and, when the position of the machine changes, to actuate a projection device associated with this position.

According to the method of the disclosure for feeding a food processing machine, a container with food is received in a receptacle of a lifting device of the food processing machine, and the container held in the receptacle is lifted from a lower position to an upper emptying position, emptied, and moved back. An optical warning symbol is projected onto and/or across the ground by way of a projection device to indicate a collision hazard area. The container can also first be moved upwards to a waiting position and then to an upper emptying position.

The disclosure also relates to a lifting device for a food processing machine, by way of which a container for food held in a receptacle can be moved from a lower position to an upper emptying position and back, where a projection device is provided and is configured and arranged such that an optical warning symbol can be projected onto and/or across the ground to indicate a collision hazard area caused by the lifting device.

All features and elements disclosed for the food processing machine may also be applied, as appropriate, to the lifting device and the method described herein, and vice versa.

The disclosure shall be explained below in more detail with reference to the following figures.

### BRIEF DESCRIPTION OF THE FIGURES

FIG. 1 shows in a simplified schematic representation of an embodiment of a food processing machine, where the receptacle is disposed in a lower position.

FIG. 2 shows the embodiment shown in FIG. 1, where the receptacle is disposed in a middle position.

FIG. 3 shows the embodiment shown in FIGS. 1 and 2, where the receptacle is disposed in an upper dump-in position.

FIG. 4 shows a further embodiment, where the receptacle is disposed in an upper dump-in position E.

### DETAILED DESCRIPTION

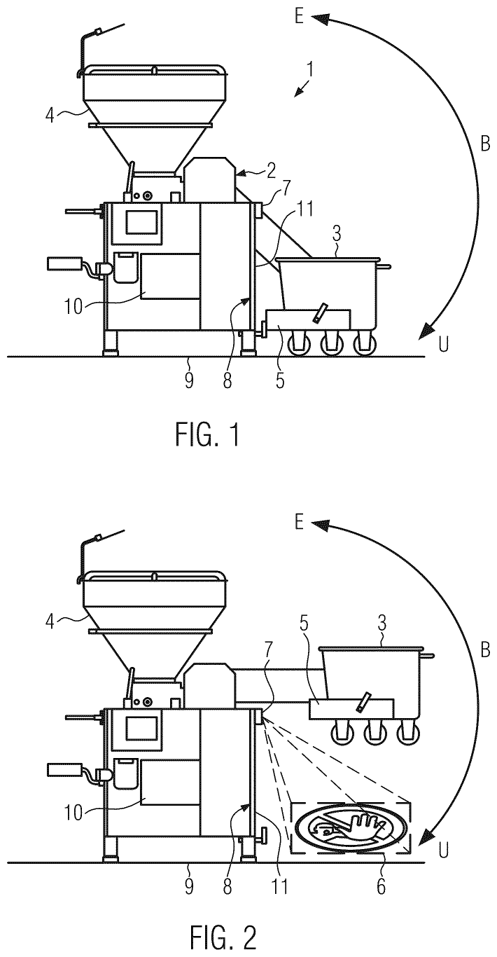

FIGS. 1 to 3 show an embodiment for feeding a food processing machine having an arm lifting device as a lifting device 2. However, a mast lifting device is equally suitable. In this embodiment, lifting device 2 is connected to machine 1, presently a filling machine.

The device is also suitable for feeding a cutter, a meat grinder, or a mixer. The machine comprises a container 3 for receiving food, e.g., sausage meat. The container, e.g., a conveyor cart or sausage meat cart, has a filling volume in the range of, for example, 100 to 1000 liters. In the case of tilting devices for large containers, the volume can be much larger, i.e., for example, up to 5000 liters. Here, container 3 is configured as a mobile container equipped with castors. Container 3 is attached in such a way that it is securely locked against falling out and in a receptacle 5 of lifting device 2, which is not specifically shown. This can be done by pushing the container into U-shaped receptacle 5 in lower position U, where it snaps into place and is locked. As can be seen from FIGS. 1-3, container 3 is arranged on an arm 12. For emptying, container 3 can be pivoted relative to arm 12 about an axis not specifically shown, for example, by a pivoting mechanism not described in detail. Arm 12, in turn, is arranged to be pivotable about a further axis, for example, to perform a lifting and lowering motion. During operation of the device, a lifting and pivot motion can also be superimposed.

The device furthermore comprises a drive. In this embodiment, the lifting device is configured, for example, as a hydraulic lifting device and comprises a hydraulic cylinder, the motion of which allows arm 12 to be raised and lowered using a respective mechanism. Machine 1, presently, for example, filling machine 11, comprises a receiving area for the food, presently filling hopper 4. The food is dumped into filling hopper 4 and further processed.

As can be seen from FIGS. 1 to 3, food processing machine 1 comprises a projector 7 which is configured and arranged such that an optical warning symbol 6 can be projected onto ground 9 for indicating a collision hazard area caused by lifting device 2, e.g., to draw attention thereto. The “collision hazard area” refers to area of motion B of receptacle 5 with container 3 and arm 12, where a collision with an operator or objects placed there can occur.

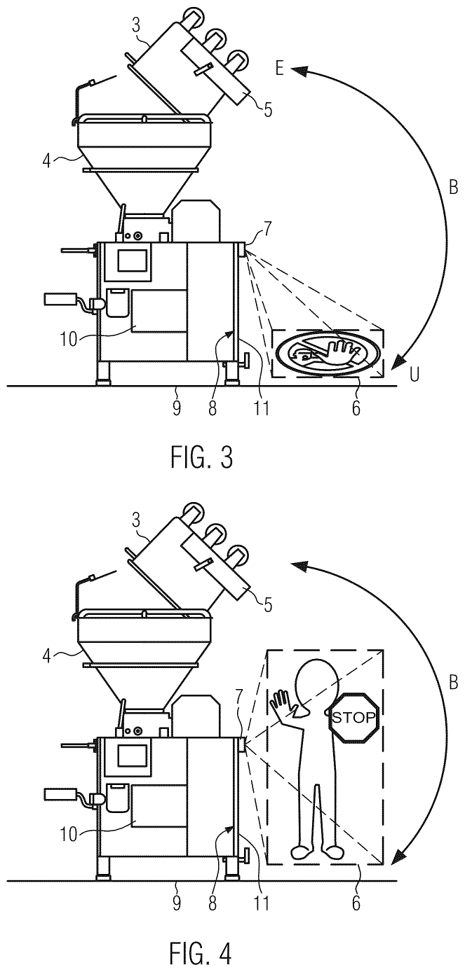

FIG. 1 shows receptacle 5 with container 3 in a lower position U. FIG. 2 shows receptacle 5 with container 3 after the former has already moved upwards and is in a center position, and FIG. 3 shows receptacle 5 with container 3 in a dump-in position E. After dumping in, receptacle 5 with empty container 3 is moved back to lower position U. This poses a risk of collision with an operator.

As can be seen in particular from FIGS. 2 and 3, projection device 7 projects warning symbol 6 onto ground 9 in this embodiment. Projection device 7 can project warning symbol 6 onto ground 9 permanently or can be switched on and off, but at least project warning symbol 6 onto the ground 9 when receptacle 5 is moved upwards. In the embodiment shown in FIGS. 1 to 3, food processing machine 1 comprises housing 8, where projection device 7 is arranged such that warning symbol 6 is projected onto the ground laterally adjacent to housing 8.

It is then irrelevant whether, in a lower position U of the receptacle, as shown, for example, in FIG. 1, projected warning symbol 6 overlaps with container 3 and receptacle 5, since there is no danger in such a low position and an operator would not go under container 3.

Projection device 7 can be, for example, an optical projector and can be integrated in particular into side wall 11 of the housing, for example in the upper third. The position at housing 8 is advantageous because the projection device can be connected to control system 10 in a simple manner at this point. In principle, the projection device could also be located elsewhere, as long as warning symbol 6 can be projected in or around the collision hazard area. It is advantageous to have the housing be a non-movable part, so that warning symbol 6 is always displayed in the same place. The projection device can also be located on the ground of machine 1, whereby the warning symbol can be projected to the appropriate location, e.g., by a lens system.

Projection device 7 can also be attached to lifting device 2, optionally to a part of the lifting device that does not move.

According to a further embodiment, not shown, food processing machine 1 comprises, for example, a floor hopper or silo, where the projection device is arranged such that warning symbol 6 can be projected laterally adjacent thereto and/or across the ground. The floor hopper or silo is connected to other components in the housing by way of lines.

Projection device 7 can also be arranged at lifting device 2, for example on a static part of the lifting device.

Projection device 7 can also be attached separately, for example to a wall, ceiling or separate holder, and connected to a control device of food processing machine 1 in such a way that the projection device can be actuated by the control device. In this embodiment, the warning symbol can be static. It is also possible to arrange several projection devices at different locations in the production room and, when the position of the machine changes, to actuate a projection device associated with this position.

Warning symbol 6 does not have to be displayed below entire motion range B or below the entire collision hazard area, i.e., it does not necessarily have to extend up to housing 8, but should at least be arranged in an area of the ground that is disposed at least in part below receptacle 5 with the container inserted, where a position as shown in FIG. 1 is presently considered. Alternatively, warning symbol 6 can also surround this area at least in sections.

Warning symbol 6 can be an image, a pictogram, a colored, e.g., red, representation etc., which alerts the operator to the danger. The exact position of warning symbol 6 is not of relevance.

FIG. 4 shows a further embodiment according to the present disclosure, which corresponds to the embodiments shown in FIGS. 1 to 3 and shows, by way of example, receptacle 5 in a dump-in position E.

The difference between the first embodiment and this embodiment is that projection device 7 can project warning symbol 6 above ground 7 into the room. It is also possible to use a projection device that projects the warning symbol onto and across the ground 9.

Projection device 7 is configured such that it projects a virtual image laterally beside housing 8 in order to draw attention to the collision hazard area. This can be a 2D or 3D projection.

Respective projection devices are known and are therefore presently not discussed in detail. When using a 3D hologram projector, for example, as shown in FIG. 4, a human-like figure can also be projected into the corresponding collision hazard area to symbolize that an operator must not enter this area. Warning symbol 6 is therefore projected at least in part into an area of motion of receptacle 5. However, it is also possible that warning symbol 6 is designed in such a way that it surrounds the area of motion B of receptacle 5 at least in sections.

In the method according to the disclosure for feeding a food processing machine 1, a container with food is pushed into a receptacle 5 of lifting device 2 of the food processing machine 1 and is received and locked therein. Container 3 held and locked in the receptacle is then lifted from a lower position U to an upper emptying position E, emptied, and moved back again.

An optical warning symbol 6 is projected onto and/or across ground 9 by a projection device 7 in order to mark a collision hazard area, i.e., to draw attention to the collision hazard area. Warning symbol 6 does not have to be disposed in the entire collision hazard area, i.e., in the entire area of motion B of receptacle 5, container 3, and arm 12, but only has to draw attention to the fact that access is not permitted in the area laterally adjacent of machine 1. In these embodiments, for example, warning symbol 6 is projected laterally adjacent to housing 8 of the food processing machine in and/or below an area of motion of receptacle 5 with the container or projected around area of motion B.

According to the present disclosure, safety for the operator can thereby be increased significantly.

1. A food processing machine, comprising:
a lifting device by way of which a container for food held in a receptacle can be moved from a lower position to an upper emptying position and back; and
a projection device which is configured and arranged such that an optical warning symbol can be projected onto and/or above the ground in order to mark a collision hazard area caused by said lifting device.

2. The food processing machine according to claim 1, wherein said food processing machine comprises a housing, wherein said projection device is arranged such that said warning symbol can be projected laterally adjacent to said housing onto and/or across said ground.

3. The food processing machine according to claim 1, wherein said food processing machine comprises a device for receiving the food from said container, wherein said projection device is arranged such that said warning symbol can be projected laterally adjacent to said device and/or across said ground.

4. The food processing machine according to claim 1, wherein said projection device is arranged such that either:
said warning symbol can be projected at least in part onto an area of the ground that is below said receptacle with said container inserted, when viewing said receptacle in a lower position, or surrounds this area at least in sections and/or
said projection device is arranged such that said warning symbol can be projected at least in part into or across an area of said receptacle with said container inserted, when viewing said receptacle in a lower position, or surrounds this area at least in part.

5. The food processing machine according to claim 1, wherein said lifting device is an arm lifting device, a mast lifting device, or a tilting device of the swing-loading type.

6. The food processing machine according to claim 1, wherein said projection device comprises an optical projector, or a projector for generating a virtual image in space.

7. The food processing machine according to claim 1, wherein said projection device is arranged at said food processing machine, wherein said projection device is arranged:
on said housing of said food processing machine, or
on a device for receiving said food, or
on the ground of said food processing machine.

8. The food processing machine according to claim 1, wherein said projection device is arranged at said lifting device.

9. The food processing machine according to claim 1, wherein said projection device is attached to a static part of said food processing machine.

10. The food processing machine according to claim 1, wherein said food processing machine comprises a control system with which said projection device can be actuated, wherein said projection device can be switched on and off by said control system and is switched on to generate said optical warning signal at the latest when said lifting device receives a signal from said control system to lift said receptacle.

11. The food processing machine according to claim 1, wherein said projection device is attached separately from the lifting device, and is connected to a control device of said food processing machine.

12. A method for feeding a food processing machine, wherein a container with food is received in a receptacle of a lifting device of said food processing machine and said container held in said receptacle is lifted from a lower position to an upper emptying position, emptied, and moved back, and
wherein an optical warning symbol is projected onto and/or across the ground by way of a projection device to indicate a collision hazard area.

13. A lifting device for a food processing machine, by way of which a container for food held in a receptacle can be moved from a lower position to an upper emptying position and back, comprising:
a projection device which is configured and arranged such that an optical warning symbol can be projected onto and/or across said ground in order to mark a collision hazard area caused by said lifting device.

14. The food processing machine according to claim 1, wherein the food processing machine comprises a filling machine.

15. The food processing machine according to claim 3, wherein the device for receiving the food from the container is a filling hopper, floor hopper, or silo.

16. The food processing machine according to claim 6, wherein the projector for generating the virtual image in space is a 3D hologram projector.

17. The food processing machine according to claim 7, wherein said projection device is arranged on said housing of said food processing machine and integrated into a side wall of said housing.

18. The food processing machine according to claim 7, wherein said projection device is arranged on the device for receiving said food, and wherein the device for receiving said food is a filling hopper, floor hopper, or silo.

19. The food processing machine according to claim 11, wherein said projection device is attached to a wall, ceiling, or separate holder.
